(19) United States
(12) Patent Application Publication
(10) Pub. No.: US 2006/0092502 A1
(43) Pub. Date: May 4, 2006

(54) Signal regenerator

(76) Inventors: Dong Churl Kim, Daejeon (KR); Dae Su Yee, Daejeon (KR); Young Ahn Leem, Daejeon (KR); Eun Deok Sim, Daejeon (KR); Kyung Hyun Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/288,008

(22) Filed: Nov. 28, 2005

(30) Foreign Application Priority Data
Feb. 12, 2004 (KR) 2004-100426

(51) Int. Cl. H01S 3/00

(52) U.S. Cl. 359/333

(57) ABSTRACT

Provided is a signal regenerator for correcting distortion of an optical signal transmitted via an optical fiber in an optical communication system, which includes semiconductor optical amplifiers having different lengths from each other, an asymmetric Mach-Zehnder interferometer that performs 2R (re-amplifying, re-shaping) regeneration, and a delay interferometer with optical waveguides having different lengths from each other, whereby the fabrication is easy and a high-speed signal regeneration is enable.

### CROSS-REFERENCE TO RELATED APPLICATION

This application claims priority to and the benefit of Korean Patent Application No. 2004-100426, filed Dec. 2, 2004, the disclosure of which is incorporated herein by reference in its entirety.

### BACKGROUND

1. Field of the Invention

The present invention relates to a signal regenerator for correcting distortion of an optical signal transmitted via an optical fiber in an optical communication system, and more specifically, to a signal regenerator that performs 2R regeneration (re-amplifying and re-shaping) of a distorted optical signal.

2. Discussion of Related Art

With the advancement of Internet, associated software and contents has been rapidly developed, and thus there is a need for development of a high-speed optical communication system capable of processing a large amount of information.

In the optical communication system to transmit an optical signal, when the signal is transmitted for a long distance through an optical fiber, the signal is distorted due to dispersion or nonlinear phenomenon. Degradation of signal quality caused by this distortion impacts a lot on the overall communication system. Therefore, there is a need for a technology of regenerating a distorted signal into an original signal.

In a typical optical communication system, the distorted optical signal is regenerated into the raw signal through 3R(Re-amplifying, Re-shaping, Re-timing) or 2R(re-amplifying, re-shaping), for which a signal regenerator is used.

A signal regenerator using electrical 3R regeneration converts the distorted optical signal into an electrical signal and 3R regenerates the electrical signal, and then, converts the electrical signal back into an optical signal. However, since an electrical circuit that converts an optical signal into an electrical signal is affected by a speed of an optical signal or format, etc., an all-optical signal to prevent the impact is desirable in comparison with the electrical regeneration.

As an example of a signal regenerator that uses 2R regeneration, a symmetric Mach-Zehnder interferometer is disclosed, each branch of which is connected to two identical gain-clamped semiconductor optical amplifier (GC-SOA) and a phase controller (U.S. Pat. No. 6,366,382).

When different currents are injected into two gain-clamped semiconductor optical amplifier, gain and phase variation of the two gain-clamped semiconductor optical amplifier are the same below the range of a saturated input power. However, the injected currents are different from each other, so that when light more than saturated input is incident, the gain and phase will be different. In this case, the phase difference is determined to be π. Further, when a phase of one branch of the interferometer is adjusted by π using a phase controller, light with intensity lower than the saturated input power destructively interferes, while light with intensity larger than the saturated input power constructively interferes. Thus, a step-like optical transfer curve is obtained. However, the above structure has a gain-clamped semiconductor optical amplifier with a diffraction grating, so that it is difficult to fabricate. Further, only 2R regeneration experiment of about 2.5 Gbit/s has been reported due to a speed limit.

As another signal regenerator using 2R regeneration, a structure using a multi-mode interference coupler (MMI) is disclosed (Jan De Merlier et al., “Experimental Demonstration of All Optical Regeneration Using an MMI-SOA”, IEEE Photonics Technology Letters, Vol. 24/5, pp. 660-662, 2002. 3).

The signal regenerator uses a multi-mode interference semiconductor optical amplifier consisting of an active layer. In the case of a 2×2 multi-mode interferometer, light incident on any one of branches can be switched in a cross or bar state, as a refractive index varies. In other words, when the signal is incident through one waveguide of two input waveguides, a carrier (electron or hole) density in the multi-mode interference semiconductor optical amplifier varies according to intensity of incident light, and the refractive index varies according to a carrier intensity variation, thus switching light in a cross or bar state. For example, when the multi-mode interference semiconductor optical amplifier is designed such that for a low power signal light is output in the cross state, while for a high power signal, light is output in the bar state, signal with an improved extinction ratio of the incident light can be obtained at a waveguide where an output is the bar state.

As yet another signal regenerator using 2R regeneration, a structure is disclosed in which one branch of the Mach-Zehnder interferometer is connected to a typical semiconductor optical amplifier, and the other branch is connected to a multi-mode interference semiconductor optical amplifier (MMI-SOA) (J. D. Merlier et al., “All-Optical 2R Regeneration based on Integrated Asymmetric Mach-Zehnder Interferometer Incorporating MMI-SOA”, Electronics Letters, Vol. 38/5, pp. 238-239, 2002.2).

For the semiconductor optical amplifier, when an input power of the optical signal becomes larger, the gains are saturated and then rapidly reduced, and accordingly, the phase also rapidly changes. However, the multi-mode interference semiconductor optical amplifier has a gain saturation input power larger than that of the typical semiconductor optical amplifier, so that a speed that a phase changes is relatively low. When this effect, i.e., a difference of phase changing speed is adapted to the Mach-Zehnder interferometer, the phase difference rapidly changes, thus making a step-like optical transfer curve. However, even with the multi-mode interference semiconductor optical amplifier, it is difficult to be adapted to a 40 Gbit/s level of very-high speed signal due to a speed limit.

### SUMMARY OF THE INVENTION

The present invention is directed to a signal regenerator that is easy to fabricate and able to regenerate a high-speed signal.

One aspect of the present invention is to provide a signal regenerator including: a first beam splitter that splits an input optical signal; first and second semiconductor optical amplifiers respectively connected to an output stage of the first beam splitter and having different lengths from each other; first phase control means connected to an output stage of the first semiconductor optical amplifier; a first optical coupler that couples optical signals output from the first phase control means and the second semiconductor optical amplifier; a second beam splitter connected to an output stage of the first optical coupler; first and second waveguides respectively connected to an output stage of the second beam splitter and having different lengths from each other; second phase control means connected to the first waveguide; third and fourth waveguides respectively connected to output stages of the second phase control means and the second waveguide and having different lengths from each other; and a second optical coupler that couples optical signals output from the third and fourth waveguides.

The first semiconductor optical amplifier is shorter than the second semiconductor optical amplifier, and the first and second semiconductor optical amplifiers have the same gain.

The second semiconductor optical amplifier is supplied with more current than the first semiconductor optical amplifier such that the first and second semiconductor optical amplifiers have the same gain.

The lengths of the first and second semiconductor optical amplifiers may be adjusted such that a phase difference is π at a low input power and 0 at a desired maximum input power.

The first waveguide is longer than the second waveguide, and the third waveguide is longer than the fourth waveguide.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a schematic diagram of a signal regenerator according to an embodiment of the present invention;

FIG. 2 is a graph showing a gain curve of a typical semiconductor optical amplifier;

FIG. 3 is a graph showing an input power to an output power of a typical semiconductor amplifier and a Mach-Zehnder interferometer of the present invention; and

FIG. 4 is a graph showing a time function of an input power, a delayed input power, and an output power of a delay interferometer according to the present invention.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

FIG. 1 is a schematic diagram of a signal regenerator according to an embodiment of the present invention.

A signal regenerator of the present invention includes an asymmetric Mach-Zehnder interferometer 21 and a delay interferometer for 2R regeneration.

The asymmetric Mach-Zehnder interferometer 21 includes an input waveguide 1 to which an optical signal is launched, a beam splitter 2 that splits an optical signal input through the input waveguide 1, semiconductor optical amplifiers 3 and 4 respectively connected to an output stage of the beam splitter 2, and having different lengths, phase control means 5 connected to an output stage of the semiconductor optical amplifier 3, and an optical coupler 6 that couples optical signals output from the phase control means 5 and the semiconductor optical amplifiers 4.

The semiconductor optical amplifier 3 is shorter than the semiconductor optical amplifier 4. Here, lengths of the semiconductor optical amplifiers 3 and 4 are adjusted such that a phase difference for a low input power is π and a phase difference for a desired maximum input power is 0. In addition, the semiconductor optical amplifiers 3 and 4 have the same gain, and more current is injected into the semiconductor optical amplifier 4 than the semiconductor optical amplifier 3 to have the same gain.

The delay interferometer 22 includes a beam splitter 7 connected to an output stage of the optical coupler 6, waveguides 8 and 9 respectively connected to an output stage of the beam splitter 7, and having different lengths, phase control means 10 connected to the waveguide 8, waveguide 11 and 12 respectively connected to an output stage of the phase control means 10 and the waveguide 9, and having different lengths, and an optical coupler 13 that combines optical signals output from the waveguides 11 and 12 to transfer the combined output signal to an output waveguide 14.

The waveguide 8 is longer than the waveguide 9, and the waveguide 11 is longer than the waveguide 12.

Hereinafter, operation of a signal regenerator according to the present invention will be described below.

An optical signal input through the input waveguide 1 is split by the beam splitter 2, and provided to the semiconductor optical amplifiers 3 and 4, respectively. The optical signal is amplified while absorbing carriers in the semiconductor optical amplifier 3 and 4. Reduction of the carriers leads to increase in the refractive index within the semiconductor optical amplifiers 3 and 4, and variation of the refractive indexes results in the phase variation of the optical signal. Here, with adjustment of the current of the semiconductor optical amplifiers 3 and 4 having different lengths from each other, gains and phases of optical signals that transmit two semiconductor optical amplifiers 3 and 4 may be the same in a region where the gains are not saturated. In addition, for a region where the gains are saturated, the optical signals that transmit the two semiconductor optical amplifiers 3 and 4 may be configured such that the gains are different but there exist a phase difference of π. In other words, the above two conditions can be satisfied by adjusting two variables of the injection current and the lengths of the semiconductor amplifiers 3 and 4.

For the former two cases, when a phase of the optical signal that transmits the semiconductor optical amplifier is changed by as much as π using the phase controller 5, in a region where the gains are not saturated, the optical signals that transmit the semiconductor optical amplifier 3 and 4 have the same gain and a π phase difference, leading to destructive interference, while in a region where the gains are saturated, the optical signals have the same phase that leads to a constructive interference.

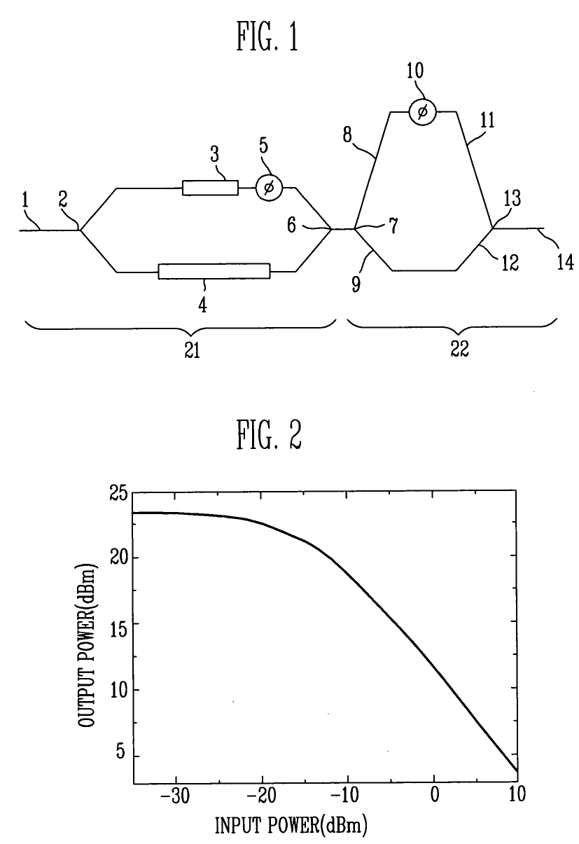

Therefore, the optical signals that transmit the asymmetric Mach-Zehnder interferometer 21 and are coupled by the optical coupler 6 have a step-like optical transfer curve (solid line), as shown in FIG. 3. With the step-like optical transfer curve, the low power incident optical signal becomes lower while the high power incident optical signal becomes flattened. FIG. 2 is a gain curve of the typical semiconductor optical amplifier, indicating that the more input power is given, the lesser the gain would be.

FIG. 3 shows an output power of the typical semiconductor optical amplifier in dBm unit as a function of an input power in a dotted line. Comparing this with the optical transfer curve shown in the solid line provides characteristics of 2R regeneration.

As shown in FIG. 3, while the characteristic curve is essentially the step-like, an absolute intensity of the input or output powers is not limited to a number described herein since it can vary according to the characteristics of the fabricated semiconductor optical amplifier. In addition, while the present embodiments has been described in the context of the asymmetric Mach-Zehnder interferometer having two semiconductor optical amplifiers 3 and 4 having different lengths for 2R regeneration, other structures may be provided to give the same effect, and thus, the present invention is not limited to the asymmetric Mach-Zehnder interferometer presented above but may be practiced with various types.

Note that the optical transfer curve shown in the solid line in FIG. 3 has a phase different of π between the low input power region where destructive interference is provided and the high input power region where constructive interference is provide, and that a signal having improved extinction ratio can be obtained.

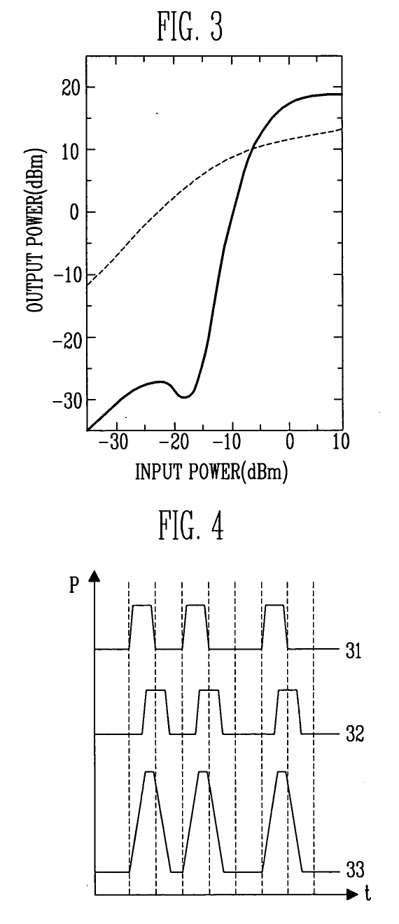

When a signal transmitting through the asymmetric Mach-Zehnder interferometer 21 incident into to the delay interferometer 22, if a time delay due to a difference of branch lengths of the delay interferometer 22, i.e., sum of shorter waveguides 9 and 10 subtracted from sum of longer waveguides 8 and 11, is adjusted to be less than a half of one bit of the zero-recursive incident signal, two signals 31 and 32 constructively interfere during a time that levels “1” (ON state) of the signals 31 and 32 are overlapped, and destructively interfere during a time that levels “0” (OFF state) of the signals 31 and 32 are overlapped, thus giving a signal with an improved extinction ratio, as shown in FIG. 4.

The signal already 2R regenerated through the asymmetric Mach-Zehnder interferometer 21 interferes at the delay interferometer 22, so that a larger extinction ratio can be obtained relative to a case where the asymmetric Mach-Zehnder interferometer 21 is not used.

A signal transmitted through an optical fiber is generally distorted due to dispersion or nonlinear phenomenon. To 2R regenerate the distorted signal, the present invention provides a signal regenerator that does not include an electrical signal conversion process. The signal regenerator of the present invention is easy to fabricate, and enables a very-high speed signal regeneration. In particular, it can be effectively adapted to a long-hole transmission system for use in long distance communication.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

What is claimed is:

1. A signal regenerator comprising:
a first beam splitter that splits an input optical signal;
first and second semiconductor optical amplifiers respectively connected to an output stage of the first beam splitter and having different lengths from each other;
first phase control means connected to an output stage of the first semiconductor optical amplifier;
a first optical coupler that couples optical signals output from the first phase control means and the second semiconductor optical amplifier;
a second beam splitter connected to an output stage of the first optical coupler;
first and second waveguides respectively connected to an output stage of the second beam splitter and having different lengths from each other;
second phase control means connected to the first waveguide;
third and fourth waveguides respectively connected to output stages of the second phase control means and the second waveguide and having different lengths from each other; and
a second optical coupler that couples optical signals output from the third and fourth waveguides.

2. The signal regenerator according to claim 1, wherein the first semiconductor optical amplifier is shorter than the second semiconductor optical amplifier.

3. The signal regenerator according to claim 1, wherein the first and second semiconductor optical amplifiers have the same gain.

4. The signal regenerator according to claim 3, wherein the second semiconductor optical amplifier is supplied with more current than the first semiconductor optical amplifier such that the first and second semiconductor optical amplifiers have the same gain.

5. The signal regenerator according to claim 1, wherein the lengths of the first and second semiconductor optical amplifiers are adjusted such that a phase difference is π at a low input power and 0 at a desired maximum input power.

6. The signal regenerator according to claim 1, wherein the first waveguide is longer than the second waveguide.

7. The signal regenerator according to claim. 1, wherein the third waveguide is longer than the fourth waveguide.
